(19) United States
(12) Patent Application Publication
(10) Pub. No.: US 2013/0254567 A1
(43) Pub. Date: Sep. 26, 2013

(54) INFRARED SIGNAL PROCESSING DEVCIE AND COMPUTER

(71) Applicants: SHAO-BO ZHANG, Shenzhen City (CN); YONG LI, Shenzhen City (CN); JIAN-HUNG HUNG, Tu-Cheng (TW)

(72) Inventors: SHAO-BO ZHANG, Shenzhen City (CN); YONG LI, Shenzhen City (CN); JIAN-HUNG HUNG, Tu-Cheng (TW)

(73) Assignees: HON HAI PRECISION INDUSTRY CO., LTD., Tu-Cheng (TW); HONG FU JIN PRECISION INDUSTRY (ShenZhen) Co., LTD., Shenzhen City (CN)

(21) Appl. No.: 13/602,233

(22) Filed: Sep. 3, 2012

(30) Foreign Application Priority Data
Mar. 23, 2012 (CN) 201210079587.0

(51) Int. Cl. G06F 1/00

(52) U.S. Cl. 713/310

(57) ABSTRACT

An infrared signal processing device includes an infrared signal receiver to receive infrared signals from a handheld remote control and a signal generating circuit connected to a power management unit of a motherboard of a computer via a cable. The device further includes a prompting unit to output a prompt and a processor to decode the infrared signals received by the infrared signal receiver. The processor controls the prompting unit to output a prompt to prompt a user to input a password when determining that the infrared signal received by the infrared signal receiver is a startup command or a shut down command. When an inputted password matches with a preset password, the processor controls the signal generating circuit to generate a control signal and send the control signal to the power management unit to start or shut down the computer as required.

### BACKGROUND

1. Technical Field

The present disclosure relates to infrared signal processing devices, and particularly to an infrared signal processing device that can be detachably coupled to a computer to allow a user to control the startup/shut down of a computer by a remote control.

2. Description of Related Art

Generally, computers are controlled through keyboards or touchpads. In either case physical contact is required between the user and the computer. However, it can be inconvenient to have to make physical contact with the computer each time to use it.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is block diagram of an infrared signal processing device in accordance with an exemplary embodiment.

FIG. 2 is circuit diagram of a signal generating unit of the infrared signal processing device of FIG. 1.

FIG. 3 is a schematic exploded view of the infrared signal processing device of FIG. 1 and a computer.

FIG. 4 is block diagram of a laptop computer in accordance with an exemplary embodiment.

### DETAILED DESCRIPTION

Embodiments of the present disclosure will be described with reference to the accompanying drawings.

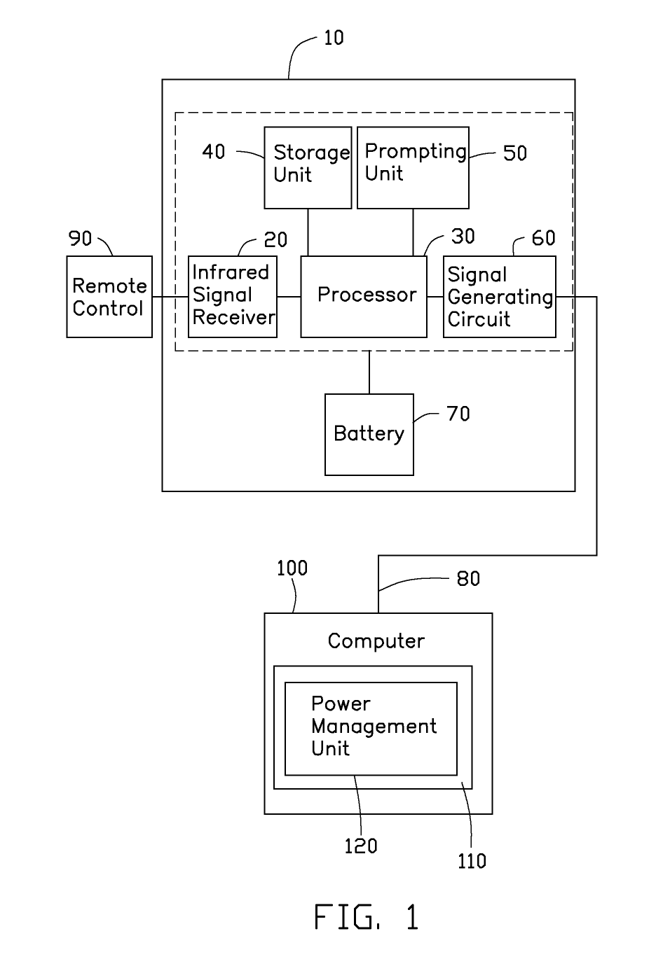

Referring to FIG. 1, an infrared signal processing device 10 includes an infrared signal receiver 20, a processor 30, a storage unit 40, a prompting unit 50, a signal generating circuit 60 and a battery 70 to provide power to the above components. The signal generating circuit 60 is connected via a cable 80 to a power management unit 120 of a motherboard 110 of a computer 100. The infrared signal receiver 20 receives an infrared signal from a handheld remote control 90. The processor 30 decodes the infrared signal received by the infrared signal receiver 20 and controls the prompting unit 50 to output a prompt, when determining that the decoded infrared signal is a startup/shutdown command The prompt asks a user to input a password. After receiving a password input by the user through the remote control 90, the processor 30 compares the inputted password with a preset password. If the inputted password matches the preset password, the processor 30 controls the signal generating circuit 60 to generates a control signal. The control signal is sent to the power management unit 120. The power management unit 120 then starts/shuts off the power supply of the computer 100.

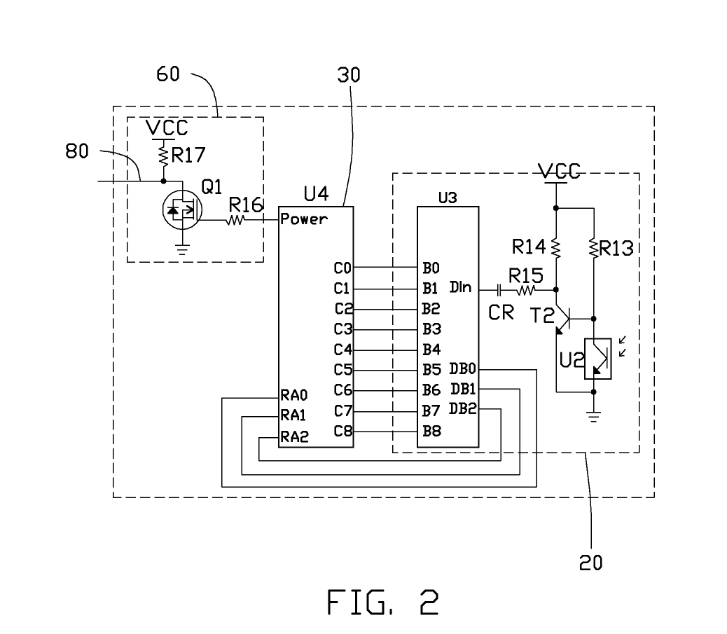

Referrring to FIG. 2, in the embodiment, the prompting unit 50 is an LED display. The signal generating circuit 60 includes a first field effect transistor (FET) Q1. The first FET gate is electrically connected to the power control port of the processor 30 through the resistor R16 and receives the command signals. The first FET source is grounded. The first FET drain is electrically connected to the second power source VCC through the resistor R17 and is connected to the power management unit 120.

Generally, when a power button of the computer 100 is pressed, the power management unit 120 receives a signal from a switch (not shown) actuated by the power button. The southbridge chip or I/O chip processes the signal from the switch and controls a triode or a gate circuit to pull down a specific pin of an ATX power supply, which causes the pins of the ATX power supply to provide a working voltage to all the hardware, such as motherboard, disk drives and the like. In the embodiment, one free end of cable 80 can be connected to a cable connecting the switch to the power management unit 120. Thus, the signal generating circuit 60 can send signals to the power management unit 120 through the cable connecting the switch to the power management unit 120.

In the embodiment, the remote control 90 includes a startup button, a shut down button, a number of number buttons and a setting button. The user can start or shut down the computer 100 by pressing the startup button or the shut down button respectively. When the setting button is pressed, the processor 30 controls the prompting unit 50 to display a user interface that includes a number of selectable item menus, which allows the user to set many function settings, such as password resetting.

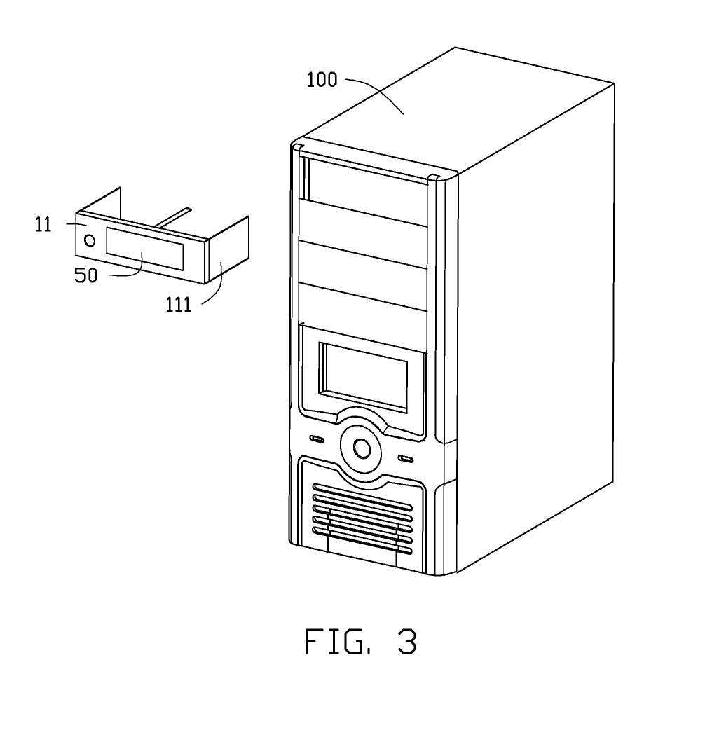

Referring to FIG. 3, the infrared signal processing device 10 includes a housing 11 and the prompting unit 50 is arranged on the front side of the housing 11. The cable 80 protrudes from the rear side of the housing 11. The housing 11 can be sized to fit a bay of the computer 100, such that the housing 11 can be fit within one bay of the computer 100. In the embodiment, the housing 11 includes two flexible magnetic sheets 111 at its opposite ends. The housing 11 can be detachably coupled to the computer 100 by the magnetic attraction between the flexible magnetic sheets 111 and the computer 100.

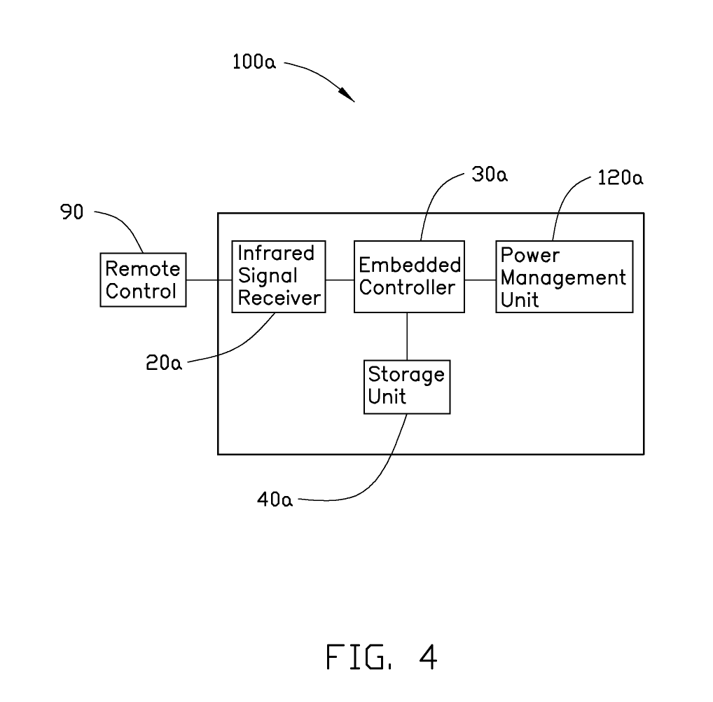

Referring to FIG. 4, in a second embodiment, a computer 100a includes an infrared signal receiver 20a, an embedded controller 30a, a storage unit 40a and a power management unit 120a. The computer 100a is a laptop type computer. The storage unit 40a is a non-volatile memory and stores a preset password. When the computer 100a is in a soft off state as defined by Advanced Configuration and Power Interface (ACPI) specification or in a sleep state defined by ACPI specification, a user can input a password via the remote control 90. The embedded controller 30a compares the inputted password received by the infrared signal receiver 20a with the preset password. If the inputted password matches with the preset password, the embedded controller 30a sends a control signal to the power management unit 120a. The power management unit 120a controls the power supply to provide the required working voltage to start/wake the computer 100a.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An infrared signal processing device comprising:
an infrared signal receiver configured to receive infrared signal from a remote control;
a signal generating circuit connected to a motherboard of a computer via a cable;
a prompting unit configured to output a prompt; and
a processor configured to decode the infrared signal received by the infrared signal receiver and to control the prompting unit to output a prompt when determining that the infrared signal received by the infrared signal receiver is a startup command or a shut down command, the prompt being configured to ask a user to input a password; wherein when an inputted password matches with a preset password, the processor controls the signal generating circuit to generate a control signal and send the control signal to the motherboard to start or shut down the computer.

2. The infrared signal processing device according to claim 1, wherein the prompting unit is an LED display.

3. The infrared signal processing device according to claim 1, further comprising a housing, wherein the housing comprises two magnetic members at opposite ends thereof, the housing is detachably connected to the computer by an attraction force between the magnetic members and the computer.

4. The infrared signal processing device according to claim 3, wherein the two magnetic members are flexible sheets.

5. A computer comprising:
an infrared signal receiver configured to receive infrared signal from a remote control;
a motherboard;
an embedded controller configured to decode the infrared signal received by the infrared signal receiver and to generate a control signal and send the control signal to the motherboard to start or shut down the computer after determining that a password inputted through the remote control matches with a preset password.

6. The computer according to claim 5 further comprising a not-volatile storage unit configured to store the preset password.
